(19) United States
(12) Patent Application Publication
(10) Pub. No.: US 2025/0070665 A1
(43) Pub. Date: Feb. 27, 2025

(54) POWER CONVERTER CONTROLLER

(71) Applicant: Renesas Electronics Corporation, Tokyo (JP)

(72) Inventors: Benoit LABBE, Harlow (GB); Allan Richard WARRINGTON, Harlow (GB); Adam Matthew BUMGARNER, Duluth, GA (US)

(73) Assignee: Renesas Electronics Corporation, Tokyo (JP)

(21) Appl. No.: 18/454,433

(22) Filed: Aug. 23, 2023

(51) Int. Cl. H02M 3/157; H02M 3/158

(52) U.S. Cl. CPC H02M 3/157; H02M 3/158

(57) ABSTRACT

A power converter controller is presented. The controller includes a ramp generator for generating a ramp signal and a ramp adjuster. The ramp adjuster compares a feedback signal of the converter with a threshold signal to obtain a comparison signal, and to adjust an amplitude of the ramp signal based on the comparison signal. Also presented is a constant on time COT power converter including the above controller.

### TECHNICAL FIELD

The present disclosure relates to a power converter controller. In particular, the present disclosure relates to a controller for a constant on time COT power converter with improved transient response.

### BACKGROUND

Constant On Time buck (CoT) converters are widely deployed in DC/DC converter applications requiring fast transient response and ease of use. The CoT control relies on a high equivalent series resistance (ESR) of the output capacitor for stable operation.

The widespread ceramic capacitors used for decoupling the output of Point of Load (PoL) buck converters have minimal ESR, making the default CoT control unstable. To circumvent the stability issue, an artificial ramp is added at one end of the CoT comparator. This ramp emulates the effect of a high ESR while keeping the advantages of low ESR output capacitors for dynamic performance.

The minimum ramp size for ensuring theoretically stable operation of a CoT converter is generally smaller than the ramp size used for practical reasons. Small ramp amplitudes lead to significant switching frequency jitter that is often considered as undesirable. This is described in the following articles: “Advantages of Constant-On-Time Control in DC/DC Converters”, Dave Baker, November 2019 https://www.monolithicpower.com/en/advantages-of-constant-on-time-control-in-dc-dc-converters; “Adaptive Constant On-Time (D-CAP™) Control Study in Notebook Applications”, Chuan Ni and Tateishi Tetsuo, SLVA281B—July 2007—Revised December 2007 https://www.ti.com/lit/an/slva281b/slva281b.pdf.

The transient response of the converter is degraded by the addition of the compensation ramp. Making the ramp larger than the minimum size for guaranteeing stable operation further reduces the converter transient response. Therefore, for large load transient conditions, the converter may be become unstable or limited by switching frequency noise. It is an object of the disclosure to address one or more of the above mentioned limitations.

### SUMMARY

According to a first aspect of the disclosure, there is provided a controller comprising a ramp generator for generating a ramp signal; a ramp adjuster adapted to compare a feedback signal of the converter with a threshold signal to obtain a comparison signal, and to adjust an amplitude of the ramp signal based on the comparison signal.

For instance the ramp signal may be a periodic signal such as a triangular signal varying between a positive amplitude and a negative amplitude. The amplitude of the ramp signal may be half of the peak to peak amplitude of the ramp signal.

Optionally, the comparison signal is a logic signal. For instance the logic signal may be a one-bit signal or a multi-bit signal.

Optionally, wherein during steady state the ramp signal has a steady state amplitude, the ramp adjuster being configured so that when the feedback signal decreases to reach a value equal or lower than the threshold signal, the logic signal changes state to reduce the amplitude of the ramp signal below the steady state amplitude.

For instance the feedback signal may decrease when the load increases suddenly.

Optionally, the controller comprises a comparator adapted to compare the ramp signal with a first reference voltage to generate a driver control signal. For instance the first reference voltage may be a target output voltage.

Optionally, the controller comprises a voltage supply adapted to generate a second reference voltage, wherein the threshold signal is equal to the second reference voltage, and wherein the second reference voltage is less than the first reference signal.

Optionally, wherein the ramp generator comprises a capacitor coupled to a resistance circuit comprising a plurality of resistances, and wherein the comparison signal is configured to activate or de-activate one or more resistances.

Optionally, wherein the ramp generator comprises a capacitor coupled to a transconductance amplifier, and wherein the comparison signal is configured to adjust a transconductance value of the transconductance amplifier.

Optionally, wherein the capacitor is coupled to ground via a variable resistance.

According to a second aspect of the disclosure, there is provided a power converter comprising a controller according to the first aspect, coupled to a power stage, the power stage comprising a high side power switch coupled to a low side power switch at a switching node; an inductor and a driver configured to drive the high side and low side power switches.

Optionally, wherein the power converter is a constant on time converter.

According to a third aspect of the disclosure, there is provided a method of controlling a converter, the method comprising:
generating a ramp signal;
comparing a feedback signal of the converter with a threshold signal to obtain a comparison signal; and
adjusting an amplitude of the ramp signal based on the comparison signal.

Optionally, the comparison signal is a logic signal.

Optionally, wherein during steady state the ramp signal has a steady state amplitude, and wherein when the feedback signal decreases to reach a value equal or lower than the threshold signal, the logic signal changes state to reduce the amplitude of the ramp signal below the steady state amplitude.

Optionally, wherein the logic signal is a one-bit signal having a first state during steady state condition and a second state during transient condition.

Optionally, wherein the logic signal is a multi-bit signal.

### DESCRIPTION OF THE DRAWINGS

The disclosure is described in further detail below by way of example and with reference to the accompanying drawings, in which:

FIG. 1 is a diagram of a conventional constant on-time buck converter;

FIG. 2 is a plot of the ramp voltage as a function of time, illustrating the operation of the converter of FIG. 1;

FIG. 3 is a flow chart of a method for controlling a COT converter according to the disclosure;

FIG. 4 is a diagram of a COT converter according to the disclosure;

FIG. 5 is an exemplary implementation of the converter of FIG. 4;

FIG. 6 is a diagram illustrating another exemplary implementation of the converter of FIG. 4;

FIG. 7 is a diagram illustrating yet another exemplary implementation of the converter of FIG. 4;

FIG. 8 is a simulation illustrating the operation of the COT converter of FIG. 1;

FIG. 9 is a simulation illustrating the operation of the COT converter of FIG. 4.

### DESCRIPTION

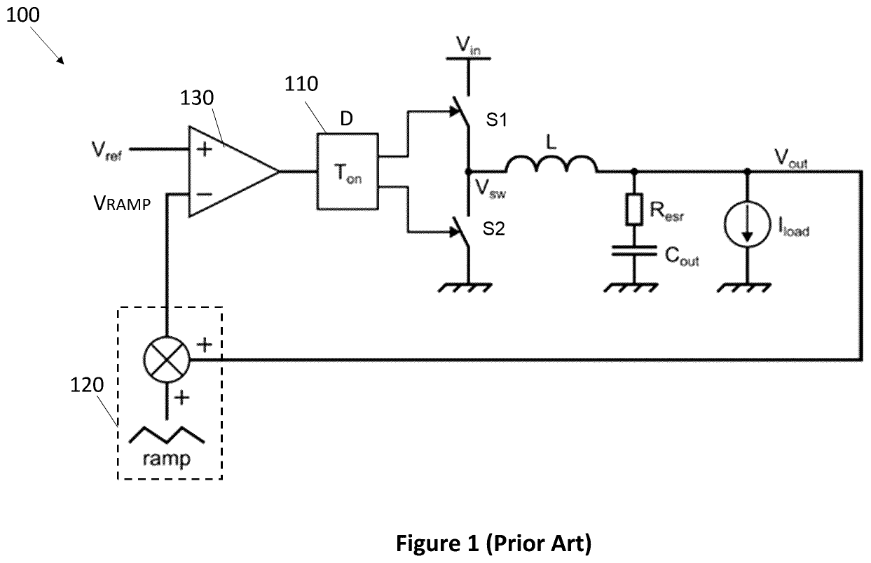

FIG. 1 is a diagram of a conventional constant on-time (CoT) buck converter. The converter 100 includes a high side power switch S1, a low side power switch S2, an inductor L, a driver 110, and an output regulation loop for regulating an output voltage of the converter. The output regulation loop includes a ramp generator 120 for generating a feedback ramp signal V_{RAMP}, and a Pulse Width Modulation PWM comparator 130. The Pulse Width Modulation PWM comparator 130 has a first input for receiving a reference signal Vref, a second input for receiving the feedback ramp voltage V_{RAMP}, and one output coupled to the driver 110.

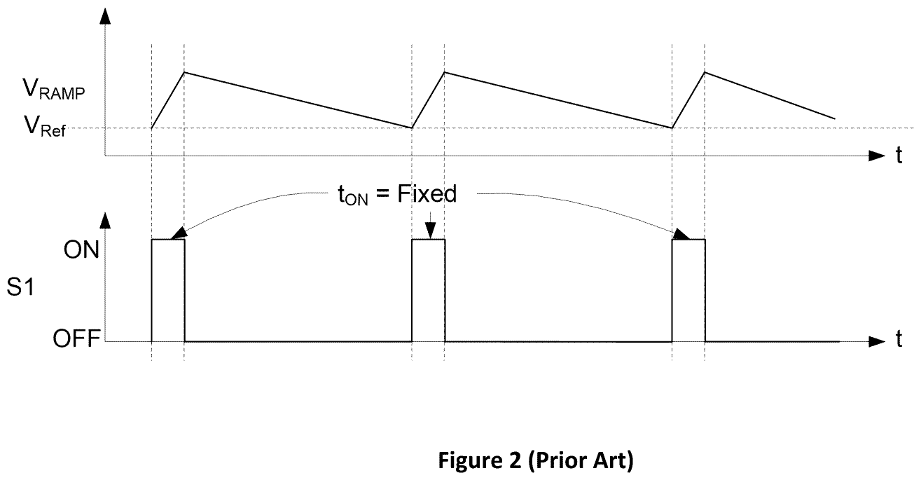

FIG. 2 is a plot illustrating the operation of the converter of FIG. 1. The top waveform shows the feedback reference voltage and the bottom waveform shows the state (on or off) of the switch S1. In operation, when the feedback ramp voltage V_{RAMP} (=Vout+ramp) reaches Vref, the comparator 130 sends a logic high to the driver 110. The driver 110 then turns on the high side switch S1 for a fixed duration D*T, where D is the duty cycle and T is the switching period, hence the name “constant on-time switching converter”. When that fixed duration expires, the driver 110 turns off the switch S1 and turns on the switch S2. The output voltage is regulated to be D*Vin, where Vin is the supply voltage. The ON-time of S1 is pre-determined and is turned OFF once the pre-determined time has been reached. To handle greater output loads, a common technique is to employ multiple power stages in parallel.

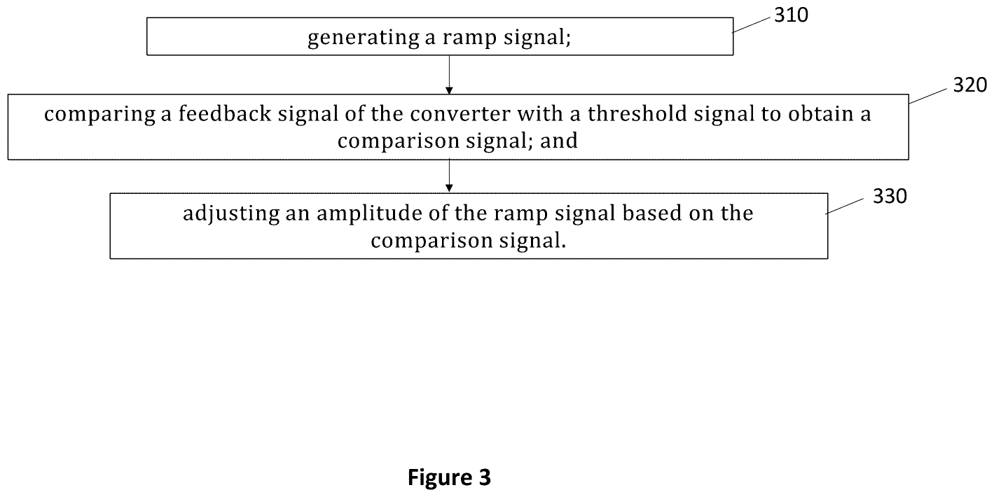

FIG. 3 is a flow chart of a method for controlling a COT converter according to the disclosure. At step 310 a ramp signal is generated. At step 320 a feedback signal of the converter is compared with a threshold signal to obtain a comparison signal. For instance the feedback signal may be the output voltage of the converter. At step 330 an amplitude of the ramp signal is adjusted based on the comparison signal.

During steady state the comparison signal has a steady state amplitude. During load transient the feedback signal decreases, and when the feedback signal reaches a value equal or lower than the threshold signal, the comparison signal increases above the steady state value to reduce the amplitude of the ramp signal.

While low switching frequency noise is desirable in most conditions, the CoT controlled converter exhibits large momentary change in switching frequency under large load transient conditions. Thus, it is possible to ignore the sizing requirement of the ramp guaranteeing low switching frequency noise under large transient conditions and lower the amplitude of the ramp momentarily. The amplitude of the ramp can then be increased instantaneously or progressively back to its normal range.

The comparison signal may be a logic signal such as a one-bit signal having only two levels: low state 0, and high state 1. Alternatively the logic signal may be a multi-bit signal having more than 2 levels. For instance a two-bit signal would have four levels, two high states (11 and 10) and two low states (00, and 01) associated with 2 bits each.

This approach permits to improve the load transient response of the converter without increasing switching frequency noise and while maintaining the stability of the converter.

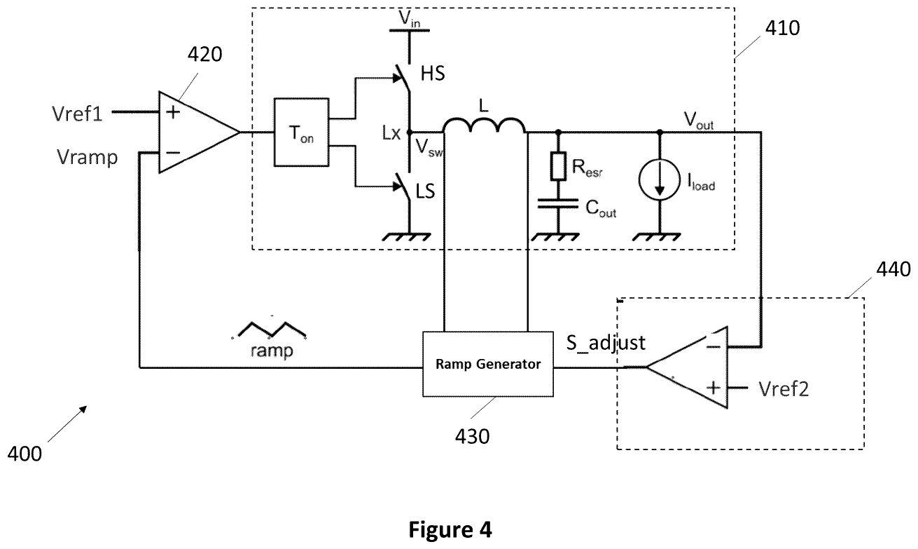

FIG. 4 is a diagram of a COT converter according to the disclosure. The power converter 400 includes a power stage 410 coupled to a controller formed of a comparator 420, a ramp generator 430 and a ramp adjuster 440.

The power stage 410 comprises a high side power switch coupled to a low side power switch at a switching node; an inductor and a driver configured to drive the high side and low side power switches. The inductor has a first terminal coupled to the switching node and a second terminal coupled to the output port of the converter to provide an output voltage Vout.

The comparator 420 has a first input for receiving a first reference voltage Vref1 and a second input for receiving a ramp voltage Vramp from the ramp generator 430.

The ramp generator 430 is coupled in parallel with the inductor L. The ramp adjuster 440 is formed of a comparator having has a first input, for instance an inverting input, for receiving the output voltage Vout, a second input, for instance a non-inverting input, for receiving a second reference voltage Vref2, and an output for providing an adjustment signal S_adjust. The second reference voltage Vref2, is also referred to as the threshold voltage Vth. The threshold voltage is selected so that Vth=Vref2<Vref1.

Optionally, the second input is provided with a voltage supply for providing a positive offset voltage Voffset. In this case the threshold voltage Vth at the second input is defined as Vth=Vref1−Voffset. The offset voltage may be chosen depending on the application.

The ramp generator 430 is coupled in parallel with the inductor L. The ramp generator has an input for receiving the output of the adjuster circuit 440 and an output coupled to the comparator 420.

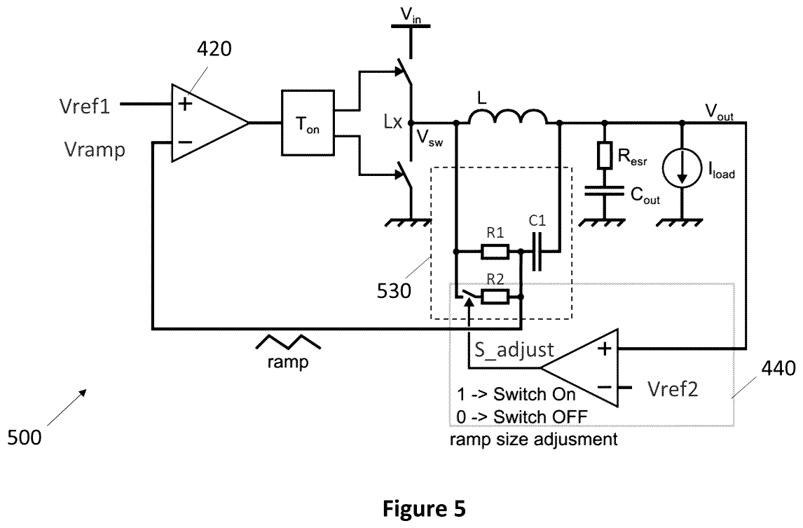

FIG. 5 is an exemplary implementation of the converter of FIG. 4. In this example the ramp generator 530 includes a capacitor C1 coupled to a resistance circuit formed of two resistances R1 and R2 coupled in parallel. The resistances R1 and R2 are coupled via a switch controlled by the adjustment signal S_adjust. When the adjustment signal is high (logic 1) the switch is closed, hence reducing the amplitude of the ramp signal. The resistance circuit may be modified to include additional resistances coupled in parallel via additional switches.

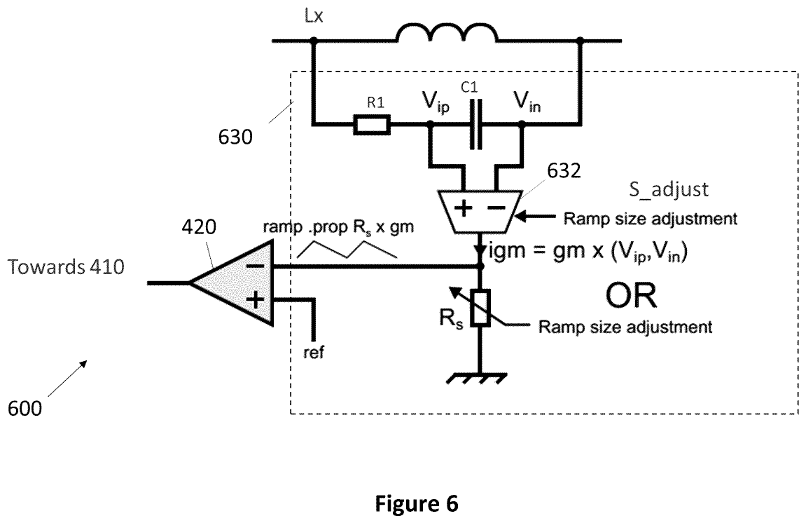

FIG. 6 is another exemplary implementation of the converter of FIG. 4. For clarity only a section of the COT circuit is represented. In this example the ramp generator 630 includes a resistance R1 in series with a capacitor C1. The capacitor C1 is coupled in parallel to a transconductance amplifier 632. The transconductance amplifier 632 has a first input coupled to a first (positive) terminal of the capacitor C1, a second input coupled to a second (negative) terminal of C1, and an output for providing the ramp signal Vramp. Optionally, the output of the transconductance amplifier 632 may be coupled to ground via a variable resistance Rs. The amplitude of the ramp signal Vramp is proportional to the product of the transconductance gm and the resistance Rs. The transconductance amplifier 632 is configured to receive the adjustment signal S_adjust to adjust the value of transconductance gm. When the adjustment signal is high (logic 1) the transconductance gm is reduced, hence reducing the amplitude of the ramp signal.

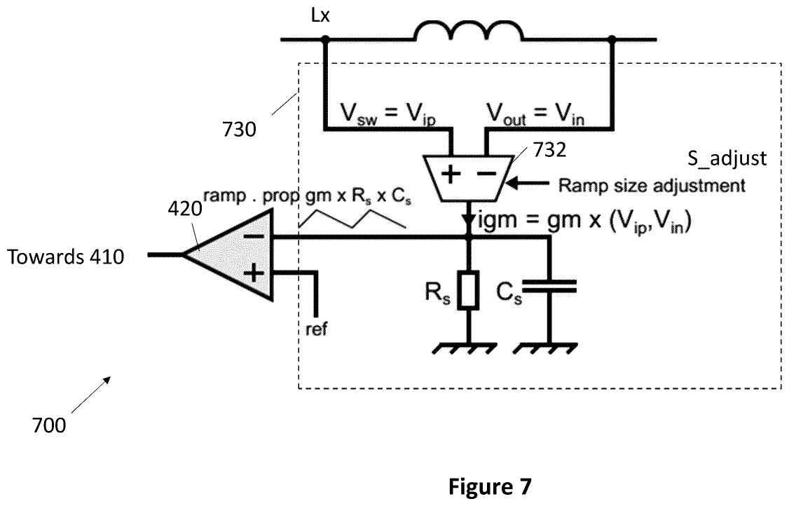

FIG. 7 is another exemplary implementation of the converter of FIG. 4. For clarity only a section of the COT circuit is represented. In this example the ramp generator 730 includes a transconductance amplifier 732 having a first input coupled to the switching node Lx, a second input coupled to the output of the converter, and an output for providing the ramp signal. The output of the transconductance amplifier 732 may be coupled to ground via a sensing resistance Rs in parallel with a sensing capacitor Cs. Rs and Cs are used to transform the current square wave, igm, into a triangular voltage, i.e. the ramp that mimics the inductor current. The amplitude of the ramp signal is proportional to the product of the transconductance gm and the resistance Rs and the capacitor Cs.

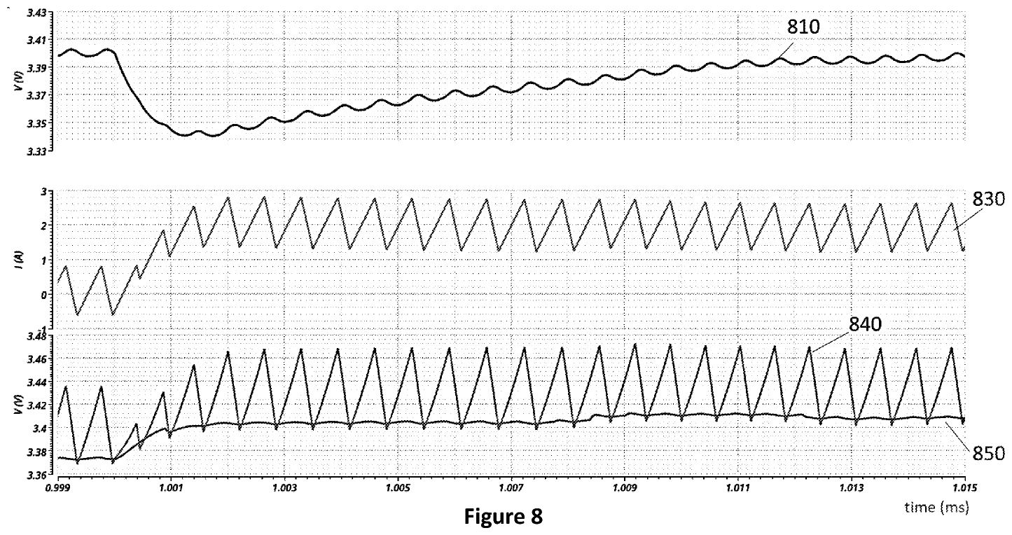

FIG. 8 is a simulation illustrating the operation of the prior art COT converter of FIG. 1. FIG. 8 shows the waveforms of the output voltage 810, the inductor current 830, the ramp signal 840 and the reference signal 850.

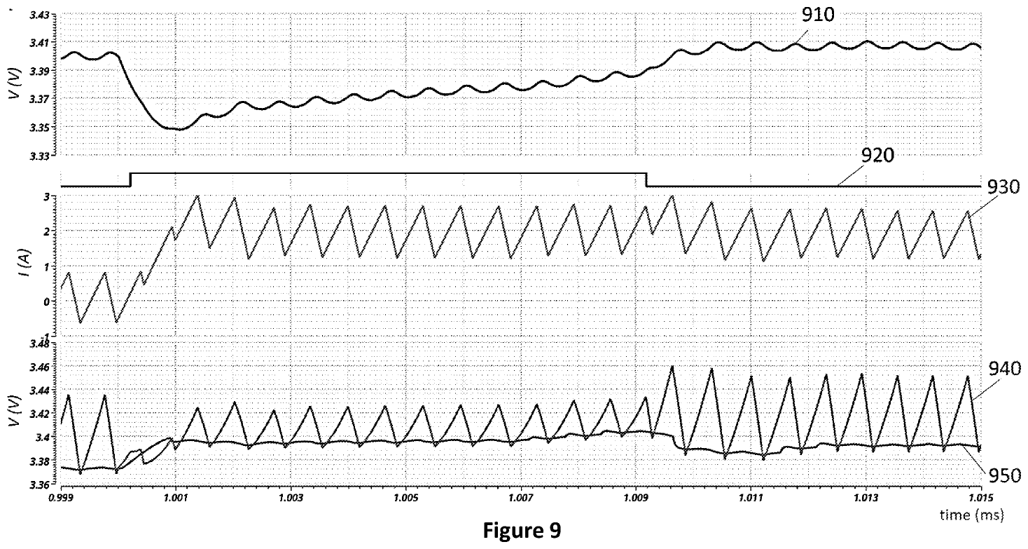

FIG. 9 is a simulation illustrating the operation of the COT converter of FIG. 4. FIG. 9 shows the waveforms of the output voltage 910, the adjustment signal S_adjust 920 (output of 440), the inductor current 930, the ramp signal 940 and the reference signal 950.

During the high state of signal 920, the amplitude of the ramp signal is reduced. Compared with the circuit of FIG. 1, the circuit of FIG. 4 reduces significantly the output voltage transient undershoot, hence improving efficiency.

The proposed approach may also be applied to multi-phase COT converters. In this case, multiple ramp adjusters may be required, one for each ramp.

A skilled person will appreciate that variations of the disclosed arrangements are possible without departing from the disclosure. Accordingly, the above description of the specific embodiments is made by way of example only and not for the purposes of limitation. It will be clear to the skilled person that minor modifications may be made without significant changes to the operation described.

1. A controller comprising
a ramp generator for generating a ramp signal;
a ramp adjuster adapted to compare a feedback signal of the converter with a threshold signal to obtain a comparison signal, and to adjust an amplitude of the ramp signal based on the comparison signal.

2. The controller as claimed in claim 1, wherein the comparison signal is a logic signal.

3. The controller as claimed in claim 2, wherein during steady state the ramp signal has a steady state amplitude, the ramp adjuster being configured so that when the feedback signal decreases to reach a value equal or lower than the threshold signal, the logic signal changes state to reduce the amplitude of the ramp signal below the steady state amplitude.

4. The controller as claimed in claim 1, comprising a comparator adapted to compare the ramp signal with a first reference voltage to generate a driver control signal.

5. The controller as claimed in claim 4, comprising a voltage supply adapted to generate a second reference voltage, wherein the threshold signal is equal to the second reference voltage, and wherein the second reference voltage is less than the first reference signal.

6. The controller as claimed in claim 1, wherein the ramp generator comprises a capacitor coupled to a resistance circuit comprising a plurality of resistances, and wherein the comparison signal is configured to activate or de-activate one or more resistances.

7. The controller as claimed in claim 1, wherein the ramp generator comprises a capacitor coupled to a transconductance amplifier, and wherein the comparison signal is configured to adjust a transconductance value of the transconductance amplifier.

8. The controller as claimed in claim 7, wherein the capacitor is coupled to ground via a variable resistance.

9. A power converter comprising a controller as claimed in claim 1, coupled to a power stage, the power stage comprising a high side power switch coupled to a low side power switch at a switching node; an inductor and a driver configured to drive the high side and low side power switches.

10. The power converter as claimed in claim 9, wherein the power converter is a constant on time converter.

11. A method of controlling a converter, the method comprising:
generating a ramp signal;
comparing a feedback signal of the converter with a threshold signal to obtain a comparison signal; and
adjusting an amplitude of the ramp signal based on the comparison signal.

12. The method as claimed in claim 11, wherein the comparison signal is a logic signal.

13. The method as claimed in claim 12, wherein during steady state the ramp signal has a steady state amplitude, and wherein when the feedback signal decreases to reach a value equal or lower than the threshold signal, the logic signal changes state to reduce the amplitude of the ramp signal below the steady state amplitude.

14. The method as claimed in claim 12, wherein the logic signal is a one-bit signal having a first state during steady state condition and a second state during transient condition.

15. The method as claimed in claim 12, wherein the logic signal is a multi-bit signal.
